(19) United States
(12) Patent Application Publication
(10) Pub. No.: US 2009/0265405 A1
(43) Pub. Date: Oct. 22, 2009

(54) Adder for Obtaining Maximum Accumulated Value of Correlation for Mode Detection in Communication System and Adding Method Using the Adder

(75) Inventor: Ki Cheol Jeong, Seoul (KR)

Correspondence Address: FISH & RICHARDSON, PC, P.O. BOX 1022, MINNEAPOLIS, MN, 55440-1022, US

(73) Assignee: Core Logic, Inc., Seoul (KR)

(21) Appl. No.: 12/427,647

(22) Filed: Apr. 21, 2009

(30) Foreign Application Priority Data
Apr. 21, 2008 (KR) 10-2008-0036743

(51) Int. Cl. G06F 7/50; G06F 7/00

(52) U.S. Cl. 708/209; 708/670

(57) ABSTRACT

Disclosed are an adder for obtaining a maximum accumulated value of correlation for mode detection in a communication system, and an adding method using the adder. According to the present disclosure, an adder for obtaining a maximum accumulated value of correlation values used to detect a mode in an orthogonal frequency division multiplexing (OFDM) system, includes one or more adding logic circuits for adding input values constituting the correlation values to stored values and outputting accumulated values, by using one or more memories; and one or more controllers for, if one of the accumulated values stored in the memories is greater than a predetermined value, shifting all of the accumulated values and the input values of the memories in a direction for decreasing the accumulated values and transmitting the shifted accumulated values and the input values to the adding logic circuits.

### CLAIM OF PRIORITY

This application claims the benefit of Korean Patent Application No. 10-2008-0036743, filed on Apr. 21, 2008, in the Korean Intellectual Property Office, the disclosure of which is incorporated herein in its entirety by reference.

### BACKGROUND

The present disclosure relates to a synchronization device in a communication system, and more particularly, to an adder for obtaining a maximum accumulated value of correlation for mode detection in an initial synchronization process between a transmitter and a receiver, and an adding method using the adder.

In general, a broadcasting system of a digital high definition television (HDTV) compresses digital data of about 1 gigabits per second (Gbps) which is obtained from a high definition video source into data of 15 to 18 megabits per second (Mbps) and transmits digital data of several tens of Mbps through a limited band channel of 6 to 8 megahertz (MHz).

As such, the broadcasting system of the HDTV should have high band efficiency. Also, when a terrestrial simulcasting method using a very high frequency (VHF)/ultra high frequency (UHF) band channel allocated for conventional analog television broadcasting is employed, the broadcasting system of the HDTV should be capable of preventing co-channel interference caused by an analog television signal.

In order to improve bandwidth transmission efficiency and to prevent interference, an orthogonal frequency division multiplexing (OFDM) method, from among digital modulation methods, has been adopted as a next-generation HD TV terrestrial broadcasting method. The OFDM method is a method of converting a row of symbols input in series into parallel symbols in units of predetermined blocks, and then multiplexing the parallel symbols to different sub-carrier frequencies.

The OFDM method uses multi-carriers which are orthogonal to each other. If two carriers are multiplied and the product is zero, the two carriers are orthogonal to each other. Orthogonal carriers are used to increase spectrum efficiency by overlapping spectrums of the orthogonal carriers.

In order to extract digital data from a signal modulated by using the OFDM method, initially, a receiver is synchronized with a transmitter. In a synchronization operation, a fast Fourier transformation (FFT) mode or a guide interval (GI) mode is detected. Since the transmitter performs inverse FFT on data to be transmitted before transmitting the data and the receiver demodulates a received signal by performing FFT on the signal, a start point and a valid data period of data (symbols) of the signal, to which FFT is to be performed, have to be identified in order to accurately perform FFT. In this case, the above-described mode detection is required because the start point and the valid data period of the symbols are varied according to the FFT mode and the GI mode.

The digital video broadcasting-handheld (DVB-H) standard has twelve different modes according to an FFT size and a GI length and the digital video broadcasting-terrestrial (DVB-T) standard has eight different modes. In this case, in order to detect a mode of received signals, the receiver uses a maximum accumulated value of a correlation coefficient according to each mode.

However, an adder to be included in the receiver to calculate the maximum accumulated value has to have a size corresponding to the size of the correlation coefficient. Accordingly, a chip size increases as the size of the correlation coefficient increases and different adders are used according to different sizes of the correlation coefficient, which may influence operating speed of a system.

Also, as the size of the correlation coefficient increases, an OFDM receiver uses an increasing amount of time to detect the FFT mode and the GI mode.

### SUMMARY

The present disclosure provides an adder for obtaining a maximum accumulated value of correlation values used to detect a mode in an orthogonal frequency division multiplexing (OFDM) system and capable of being realized regardless of the size of a correlation coefficient, preventing increase of a chip size which is caused by the increase of the size of the correlation coefficient, minimizing influence on an operating speed of the OFDM system, and increasing speed of an adding operation.

The present disclosure also provides an adding method of obtaining a maximum accumulated value of correlation values used to detect a mode in an orthogonal frequency division multiplexing (OFDM) system and capable of realizing an adder regardless of the size of a correlation coefficient, preventing increase of a chip size which is caused by the increase of the size of the correlation coefficient, minimizing influence on an operating speed of the OFDM system, and increasing speed of an adding operation.

According to an aspect of the present disclosure, there is provided an adder for obtaining a maximum accumulated value of correlation values used to detect a mode in an orthogonal frequency division multiplexing (OFDM) system, the adder including one or more adding logic circuits for adding input values constituting the correlation values to stored values and outputting accumulated values, by using one or more memories; and one or more controllers for, if one of the accumulated values stored in the one or more memories is greater than a predetermined value, shifting all of the accumulated values and the input values of the one or more memories in a direction for decreasing the accumulated values and transmitting the shifted accumulated values and the input values to the one or more adding logic circuits.

If a first memory in which ‘i’ most significant bits (MSBs) of an accumulated value have a value x exists from among the one or more memories, the one or more controllers may shift all of the accumulated values of the one or more memories by a number of bits corresponding to a location N of an MSB having a logic high level from among bits of a memory having the greatest accumulated value from among the others of the one or more memories, wherein i, x, and N are natural numbers.

According to another aspect of the present disclosure, there is provided an adding method of obtaining a maximum accumulated value of correlation values used to detect a mode in an orthogonal frequency division multiplexing (OFDM) system, the adding method including receiving input values constituting the correlation values, and accumulated values; if one of the accumulated values is equal to or greater than a predetermined value, shifting all of the accumulated values in a direction for decreasing the accumulated values; shifting the input values by the number of bits by which the accumulated values are shifted; and adding the shifted accumulated values to the input values.

The shifting of the accumulated values may include detecting a first accumulated value in which i MSBs have a value x from among the accumulated values; detecting a second accumulated value having the greatest size from among accumulated values other than the first accumulated value; and shifting all of the accumulated values by a number of bits corresponding to a location N of an MSB having a logic high level from among bits of the second accumulated value.

### BRIEF DESCRIPTION OF THE DRAWINGS

The above and other features and advantages of the present disclosure will become more apparent by describing in detail exemplary embodiments thereof with reference to the attached drawings in which:

FIG. 1 is a schematic diagram of a general adder;

FIG. 2 is a schematic diagram of an adder according to an embodiment of the present disclosure;

FIG. 3 is a schematic diagram of memories included in adding logic circuits of the adder shown in FIG. 2;

FIGS. 4 and 5 are schematic diagrams of adders according to other embodiments of the present disclosure;

FIGS. 6A and 6B are diagrams for describing a shifting operation of accumulated values in memories when the adder shown in FIG. 2 operates;

FIG. 7 is a flowchart of an adding method of obtaining a maximum accumulated value of correlation values used to detect a mode in an orthogonal frequency division multiplexing (OFDM) system, according to an embodiment of the present disclosure; and

FIG. 8 is a flowchart illustrating a detailed version of the adding method shown in FIG. 7, according to an embodiment of the present disclosure.

### DETAILED DESCRIPTION

The attached drawings for illustrating exemplary embodiments of the present invention are referred to in order to gain a sufficient understanding of the present disclosure, the merits thereof, and the objectives accomplished by the implementation of the present disclosure.

Hereinafter, the present disclosure will be described in detail by explaining embodiments of the disclosure with reference to the attached drawings. Like reference numerals in the drawings denote like elements.

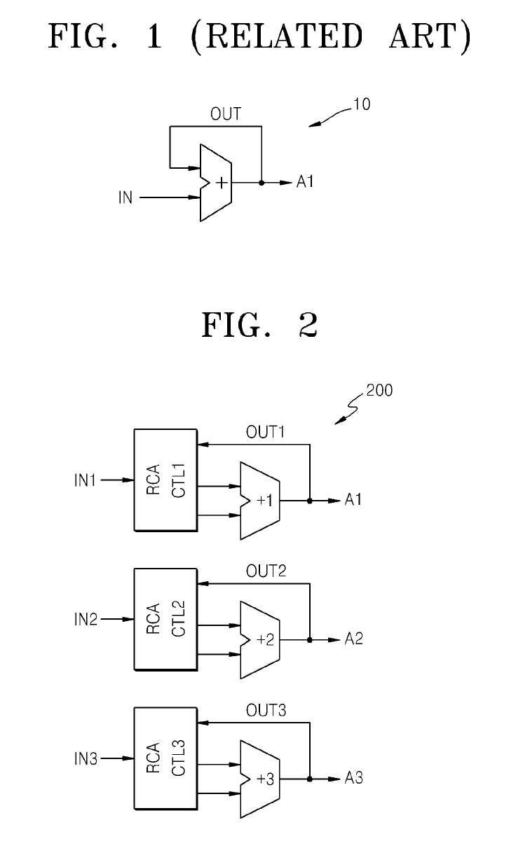

FIG. 1 is a schematic diagram of a general adder 10.

Referring to FIG. 1, the general adder 10 adds an input value IN to an output value OUT so as to output a first accumulated value Al. In this case, as described above in the description of the related art, the general adder 10 has to have a storage space corresponding to the size of the input value IN and the first accumulated value A1, in order to calculate the first accumulated value A1.

FIG. 2 is a schematic diagram of an adder 200 according to an embodiment of the present disclosure.

Referring to FIG. 2, the adder 200 includes one or more adding logic circuits and controllers, e.g., first through third adding logic circuits +1 through +3 and first through third controllers RCA CTL1 through RCA CTL3. The first through third adding logic circuits +1 through +3 are respectively connected to the first through third controllers RCA CTL1 through RCA CTL3 that respectively output first through third accumulated values A1 through A3 or first through third stored values OUT1 through OUT3. Meanwhile, first through third input values IN1 through IN3 and the first through third stored values OUT1 through OUT3 are respectively input to the first through third controllers RCA CTL1 through RCA CTL3, are respectively changed by predetermined logic in the first through third controllers RCA CTL1 through RCA CTL3, and are respectively output to the first through third adding logic circuits +1 through +3.

The adder 200 according to the current embodiment may be an adder for calculating a maximum accumulated value of correlation values used to detect a mode in an orthogonal frequency division multiplexing (OFDM) system. Although the adder 200 illustrated in FIG. 2 includes three adding logic circuits that respectively use three correlation values as input values, if four or more correlation values are accumulated, the adder 200 may include four or more controllers and adding logic circuits.

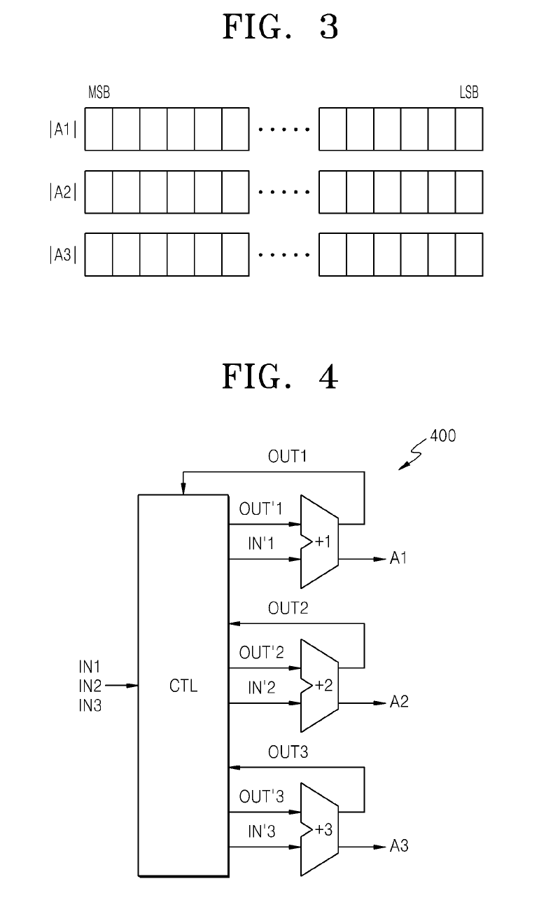

Here, the function of each of the first through third adding logic circuits +1 through +3 is the same as the function of the adding logic circuit 10 illustrated in FIG. 1. Meanwhile, the first through third controllers RCA CTL1 through RCA CTL3 respectively perform active control on memories of the first through third adding logic circuits +1 through +3 so as to maintain minimum use of the memories. The operation of the adder 200 will now be described in detail with reference to FIG. 3.

FIG. 3 is a schematic diagram of first through third memories |A1| through |A3| included in the first through third adding logic circuits +1 through +3 illustrated in FIG. 2. FIG. 3 will be described in conjunction with FIG. 2.

Referring to FIG. 3, the first through third adding logic circuits +1 through +3 respectively include the first through third memories |A1| through |A3| in order to perform an accumulation operation. That is, the first adding logic circuit +1 may include the first memory |A1|, the second adding logic circuit +2 may include the second memory |A2|, and the third adding logic circuit +3 may include the third memory |A3|. The size of the first through third memories |A1| through |A3| may be the same or different. However, if the first through third memories |A1| through |A3| have different sizes, when the accumulation operation is performed, an accumulated value may not exceed the size of the smallest memory.

The first through third adding logic circuits +1 through +3 respectively add the first through third input values IN1 through IN3 constituting correlation values to the first through third stored values OUT1 through OUT3 so as to output the first through third accumulated values A1 through A3. In this case, the first through third stored values OUT1 through OUT3 and the first through third accumulated values A1 through A3 are separated from each other for convenience of explanation and substantially have the same values. That is, when the first through third accumulated values A1 through A3 are re-input to the first through third adding logic circuits +1 through +3, the first through third accumulated values A1 through A3 are referred to as the first through third stored values OUT1 through OUT3.

The first through third memories |A1| through |A3| respectively store the first through third accumulated values A1 through A3 of the first through third adding logic circuits +1 through +3. That is, the first memory |A1| stores the first accumulated value A1 of the first adding logic circuit +1, the second memory |A2| stores the second accumulated value A2 of the second adding logic circuit +2, and the third memory |A3| stores the third accumulated value A3 of the third adding logic circuit +3.

If an accumulated value stored in a predetermined memory is equal to or greater than a predetermined value, the first through third controllers RCA CTL1 through RCA CTL3 shift all of the first through third accumulated values A1 through A3 of the first through third memories |A1| through |A3| in a direction for decreasing the accumulated value, and also shift the first through third input values IN1 through IN3 by the number of bits by which the accumulated value is shifted. Also, the first through third controllers RCA CTL1 through RCA CTL3 respectively output first through third shifted accumulated values OUT′1 through OUT′3 (refer to FIG. 4) and the first through third input values IN1 through IN3 to the first through third adding logic circuits +1 through +3.

In this case, each of the first through third adding logic circuits +1 through +3 may include a controller. Thus, as illustrated in FIG. 2, the adder 200 including the first through third adding logic circuits +1 through +3 may include the first through third controllers RCA CTL1 through RCA CTL3. However, although not illustrated in FIG. 2, the first through third controllers RCA CTL1 through RCA CTL3 have to respectively obtain information regarding all of the first through third accumulated values A1 through A3 of the first through third memories |A1| through |A3|.

Meanwhile, although the first through third adding logic circuits +1 through +3 include the first through third memories |A1| through |A3| in FIG. 3, alternatively, the first through third memories |A1| through |A3| may be external memories so that the first through third adding logic circuits +1 through +3 may use the first through third memories |A1| through |A3| when an adding operation is performed.

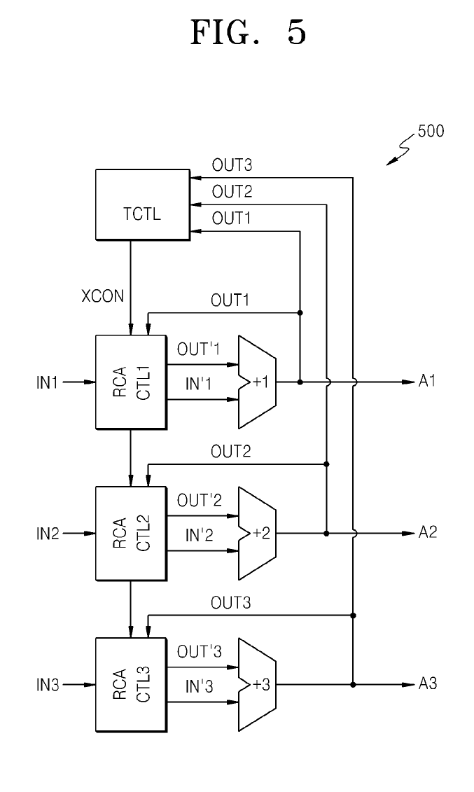

FIGS. 4 and 5 are schematic diagrams of adders 400 and 500 according to other embodiments of the present disclosure.

Referring to FIG. 4, the adder 400 is similar to the adder 200 illustrated in FIG. 2 but includes only one controller CTL. As such, the controller CTL is shared by all of first through third adding logic circuits +1 through +3, performs a shifting operation on each of first through third input values IN1 through IN3 and first through third stored values OUT1 through OUT3, and outputs first through third shifted input values IN′1 through IN′3 and first through third shifted stored values OUT′1 through OUT′3 respectively to the first through third adding logic circuits +1 through +3.

Referring to FIG. 5, the adder 500 is similar to the adder 200 illustrated in FIG. 2 but further includes an integrated controller TCTL for integrally controlling first through third controllers RCA CTL1 through RCA CTL3. As such, the integrated controller TCTL may receive information regarding first through third accumulated values A1 through A3 of memories, i.e., first through third stored values OUT1 through OUT3, from first through third adding logic circuits +1 through +3 and may transmit an integrated control signal XCON to the first through third controllers RCA CTL1 through RCA CTL3.

Operations of the adders 200, 400, and 500 respectively illustrated in FIGS. 2, 4, and 5 will now be described with detailed examples. In this regard, the operations of the adders 400 and 500 are similar to the operation of the adder 200 and thus the operation of the adder 200 will be representatively described.

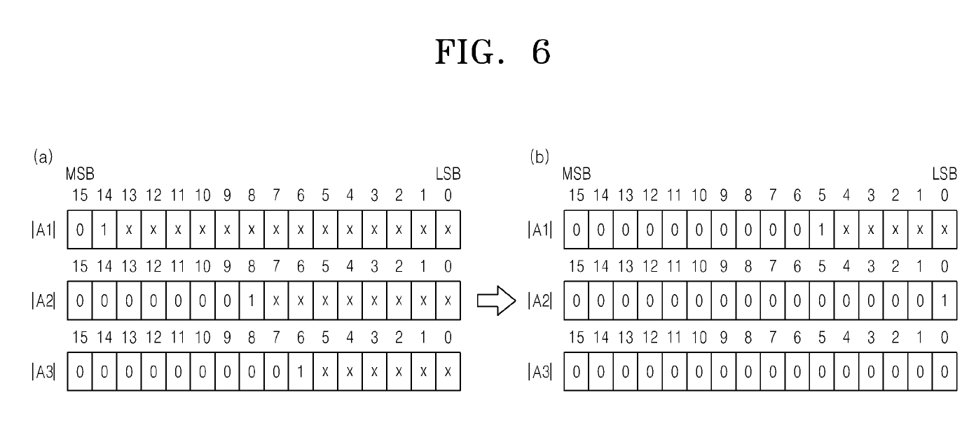

FIGS. 6A and 6B are diagrams for describing a shifting operation of first through third accumulated values in the first through third memories |A1| through |A3| when the adder 200 illustrated in FIG. 2 operates. FIG. 6A illustrates the first through third accumulated values respectively stored in the first through third memories |A1| through |A3| before performing the shifting operation and FIG. 6B illustrates the first through third accumulated values respectively stored in the first through third memories |A1| through |A3| after performing the shifting operation. FIGS. 6A and 6B will be described in conjunction with FIG. 2.

Referring to FIGS. 6A and 6B, each of the first through third memories |A1| through |A3| have a size of sixteen bits. As described above with reference to FIG. 2, the first through third adding logic circuits +1 through +3 add the first through third input values IN1 through IN3 to the first through third stored values OUT1 through OUT3 and output the first through third accumulated values A1 through A3.

If i most significant bits (MSBs) of an accumulated value stored in one of the first through third memories |A1| through |A3| have a value x (x is a natural number), the first through third controllers RCA CTL1 through RCA CTL3 compare accumulated values of the others of the first through third memories |A1| through |A3|. If a location of an MSB having a logic high level, i.e., a value 1 in a memory having the greatest accumulated value from among the others of the first through third memories |A1| through |A3| has a value N (N is a natural number), the first through third controllers RCA CTL1 through RCA CTL3 respectively shift current first through third accumulated values A1 through A3 in the first through third memories |A1| through |A3| by the number of bits corresponding to the location N in a direction for decreasing the first through third accumulated values A1 through A3.

For example, it is assumed that the first through third controllers RCA CTL1 through RCA CTL3 perform the shifting operation when i has a value 2 and x has a value 1, that is, two MSBs have a value ‘01’. Also, It is assumed that the first through third accumulated values A1 through A3 respectively stored in the first through third memories |A1| through |A3| at a predetermined point of time are as illustrated in FIG. 6A. That is, it is assumed that the first accumulated value A1 of the first memory |A1| is ‘01xxxxxxxxxxxxx’, the second accumulated value A2 of the second memory |A2| is ‘00000001xxxxxxx’, and the third accumulated value A3 of the third memory |A3| is ‘0000000001xxxxx’. In this case, x may represent a value 0 or 1.

The first through third controllers RCA CTL1 through RCA CTL3 detect that two MSBs of the first accumulated value A1 stored in the first memory |A1| have a value ‘01’. Then, the first through third controllers RCA CTL1 through RCA CTL3 compare the second accumulated value A2 of the second memory |A2| to the third accumulated value A3 of the third memory |A3|. In this case, all of the first through third controllers RCA CTL1 through RCA CTL3 may receive accumulated value information from other controllers so as to separately compare the second accumulated value A2 to the third accumulated value A3, or one of the first through third controllers RCA CTL1 through RCA CTL3 may receive accumulated value information from other controllers so as to integrally compare the second accumulated value A2 to the third accumulated value A3.

In FIG. 6A, the second accumulated value A2 of the second memory |A2| is greater than the third accumulated value A3 of the third memory |A3|. Accordingly, the first through third controllers RCA CTL1 through RCA CTL3 detect the location N of an MSB having a value 1 from among bits of the second accumulated value A2 of the second memory |A2|.

As a result, the location N of the MSB having a value 1 from among bits of the second accumulated value A2 of the second memory |A2| has a value 9. However, since least significant bits (LSBs) of the second memory |A2| is counted from a value 0, the location N of the MSB having a value 1 in the second memory |A2| is shown to have a value of 8.

If the first through third controllers RCA CTL1 through RCA CTL3 obtain the location N as described above, the first through third controllers RCA CTL1 through RCA CTL3 shift all of the first through third accumulated values A1 through A3 in the first through third memories |A1| through |A3| by N−1 bits in an LSB direction and also shift the first through third input values IN1 through IN3 by N−1 bits in the LSB direction. In this case, the location N−1 is merely an example and the present disclosure is not limited thereto. However, if the shifting operation is performed by shifting the first through third accumulated values A1 through A3 by a number of bits equal to or greater than N bits, each of the second accumulated value A2 of the second memory |A2| and the third accumulated value A3 of the third memory |A3| has a value 0. Thus, the shifting operation may be performed by shifting the first through third accumulated values A1 through A3 by a number of bits equal to or less than N−1 bits.

As a result, each of the first through third accumulated values A1 through A3 illustrated in FIG. 6A is shifted by eight bits in the LSB direction as illustrated in FIG. 6B. Meanwhile, although not illustrated in FIGS. 6A and 6B, the first through third input values IN1 through IN3 are also shifted similarly to the first through third accumulated values A1 through A3. That is, each of the first through third input values IN1 through IN3 is also shifted by eight bits in the LSB direction.

The first through third controllers RCA CTL1 through RCA CTL3 repeat the above-described shifting operation M times (M is a natural number), and then output an accumulated value of a memory in which i MSBs of the accumulated value have a value x, as a maximum accumulated value. In this case, M may be previously determined by a user or a system designer before performing an adding operation.

As such, according to the current embodiment, even if a memory of an adder is completely used, an adding operation may be continuously performed by performing the above-described shifting operation. Accordingly, a maximum accumulated value may be obtained by using an input value and an accumulated value having a size smaller than an actual correlation value and thus the speed of the adding operation may be increased. Furthermore, a variation in operating speed of a system due to the size of a correlation value may be prevented.

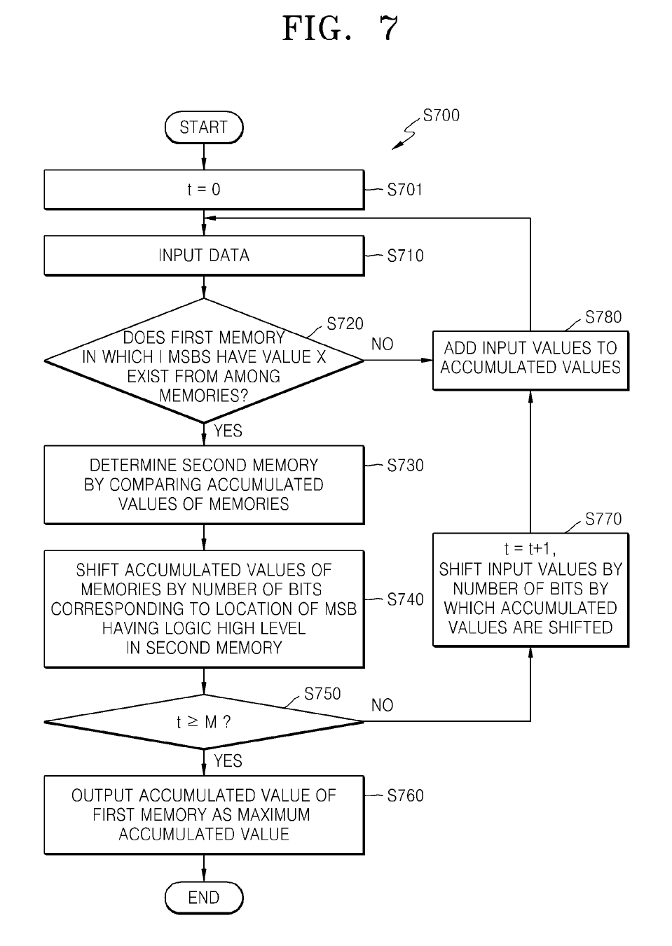

FIG. 7 is a flowchart of an adding method S700 of obtaining a maximum accumulated value of correlation values used to detect a mode in an OFDM system, according to an embodiment of the present disclosure. FIG. 7 will be described in conjunction with FIG. 2.

Referring to FIG. 7, in the adding method S700, initially, a count value t is initialized to zero (operation S701), and then the first through third controllers RCA CTL1 through RCA CTL3 receive data, i.e., input values constituting correlation values, and accumulated values (operation S710). Here, an accumulated value has the same meaning as a stored value as described above with reference to FIG. 3 and the state of a memory may be identified by using the accumulated value. Then, the first through third controllers RCA CTL1 through RCA CTL3 determine whether a memory in which i MSBs have a value x exists (operation S720). Then, if a memory in which i MSBs have a value x exists, an accumulated value of another memory is detected (operation S730). If a memory in which i MSBs have a value x does not exist, the input values are added to the accumulated values (operation S780) and then the data is re-input (operation S710). For convenience of explanation, the memory in which i MSBs have a value x is referred to as a first memory and the other memory is referred to as a second memory.

A location of an MSB having a logic high level, i.e., a value 1 is detected from among bits in the second memory and all of the accumulated values are shifted by the number of bits corresponding to the detected location of the MSB in a direction for decreasing the accumulated values (operation S740). Here, if a plurality of second memories exist, a location of an MSB having a logic high level is detected from among bits in the second memories and all of the accumulated values are shifted by the number of bits corresponding to the location of the MSB in the direction for decreasing the accumulated values. Here, the accumulated value of the first memory is also shifted. Meanwhile, as described above with reference to FIGS. 6A and 6B, the number of bits corresponding to a location to be shifted may be N−1 if the location of the MSB has a value N. However, the number of bits to be shifted is not limited to N−1 and may be arbitrarily set according to a system. In this case, the MSB having a logic high level must exist even after performing a shifting operation.

Then, the count value t is compared to the number of repetitions M of the above-described shifting operation (operation S750). If the count value t is less than the number of repetitions M, the count value t is increased by one and the input values are shifted by the number of bits corresponding to the location by which the accumulated values are shifted (operation S770), the input values are added to the accumulated values (operation S780), and then the adding method S700 returns to operation S710. If the count value t is equal to or greater than the number of repetitions M, the accumulated value of the first memory is output as a maximum accumulated value (operation S760).

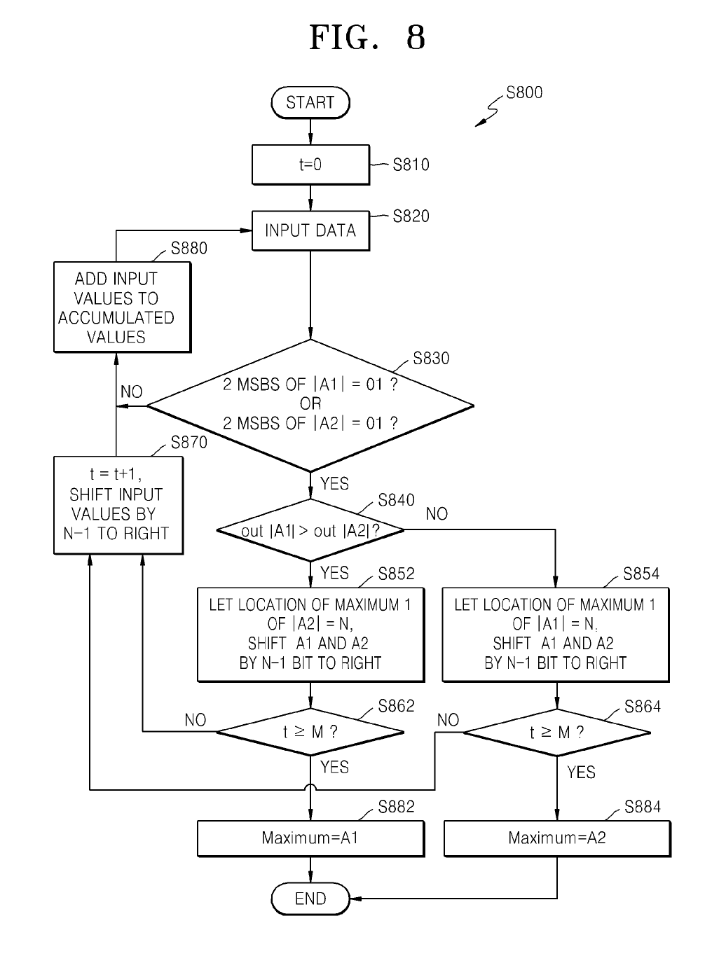

FIG. 8 is a flowchart of an adding method S800 constituting a detailed version of the adding method S700 illustrated in FIG. 7, according to an embodiment of the present disclosure. For convenience of explanation, FIG. 8 will be described on the assumption that two accumulated values, i.e., first and second accumulated values A1 and A2 exist.

Referring to FIG. 8, in the adding method S800, initially, a count value t is initialized to zero (operation S810). In this case, as described above with reference to FIG. 7, the count value t is used to check the number of repetitions M of the shifting operation. Then, data, i.e., input values and first and second accumulated values A1 and A2 are received (operation S820) and it is determined whether an accumulated value in which two MSBs having a value ‘01’ exists in first and second memories |A1| and |A2| (operation S830). If an accumulated value in which two MSBs having a value ‘01’ does not exist from among the first and second accumulated values A1 and A2, the input values are added to the first and second accumulated values A1 and A2 (operation S880) and then the adding method S800 returns to operation S820.

If an accumulated value in which two MSBs having a value ‘01’ exists from among the first and second accumulated values A1 and A2, the sizes of the first and second accumulated values A1 and A2 are compared to each other (operation S840). In this case, if the size of the first accumulated value A1 is greater than the size of the second accumulated value A2, a location N of an MSB of the second accumulated value A2 is obtained and both of the first and second accumulated values A1 and A2 are shifted by N−1 bits in an LSB direction of the first and second memories |A1| and |A2| (operation S852). On the other hand, if the size of the second accumulated value A2 is equal to or greater than the size of the first accumulated value A1, a location N of an MSB of the first accumulated value A1 is obtained and both of the first and second accumulated values A1 and A2 are shifted by N−1 bits in an LSB direction of the first and second memories |A1| and |A2| (operation S854).

Then, it is determined whether the count value t reaches the number of repetitions M of the shifting operation (operations S862 and S864). If the count value t does not reach the number of repetitions M of the shifting operation, the count value t is increased by one and the input values are shifted by N−1 bits (operation S870), the input values are added to the first and second accumulated values A1 and A2 (operation S880), and then the adding method S800 returns to operation S820.

On the other hand, if the count value t reaches the number of repetitions M of the shifting operation, a maximum accumulated value is output (operations S882 and S884). In this case, the maximum accumulated value is an accumulated value shifted by N−1 bits in a memory in which two MSBs have a value ‘01’.

As described above, according to the present disclosure, if an accumulated value, which is obtained using a correlation value, stored in a memory of an adder is equal to or greater than a predetermined value, input values and accumulated values of the adder are shifted by a predetermined number of bits and are added to each other and thus a maximum accumulated value may be obtained by using an input value and an accumulated value having a size less than the size of an actual correlation value. Accordingly, the speed of an adding operation may be increased.

Also, since the size of a memory may be realized regardless of the size of a correlation value, a variation in operating speed of a system due to the size of the correlation value may be prevented.

While the present disclosure has been particularly shown and described with reference to exemplary embodiments thereof, it will be understood by those of ordinary skill in the art that various changes in form and details may be made therein without departing from the spirit and scope of the present disclosure as defined by the following claims.

What is claimed is:

1. An adder for obtaining a maximum accumulated value of correlation values used to detect a mode in an orthogonal frequency division multiplexing (OFDM) system, the adder comprising:
one or more adding logic circuits for adding input values constituting the correlation values to stored values and outputting accumulated values, by using one or more memories; and
one or more controllers for, if one of the accumulated values stored in the one or more memories is greater than a predetermined value, shifting all of the accumulated values and the input values of the one or more memories in a direction for decreasing the accumulated values and transmitting the shifted accumulated values and the input values to the one or more adding logic circuits.

2. The adder of claim 1, wherein, if a first memory in which i most significant bits (MSBs) of an accumulated value have a value x exists from among the one or more memories, the one or more controllers shift all of the accumulated values of the one or more memories by a number of bits corresponding to a location N of an MSB having a logic high level from among bits of a memory having the greatest accumulated value from among the others of the one or more memories, wherein i, x, and N are natural numbers.

3. The adder of claim 2, wherein the one or more controllers shift all of the accumulated values of the one or more memories by. N−1 bits.

4. The adder of claim 2, wherein the adder outputs the accumulated value of the first memory as the maximum accumulated value after repeatedly shifting all of the accumulated values of the one or more memories by the number of bits corresponding to the location N M times, wherein M is a natural number.

5. The adder of claim 1, wherein the accumulated values and the input values are shifted by the same number of bits.

6. The adder of claim 1, wherein the number of the one or more adding logic circuits corresponds to the number of the correlation values used to detect the mode.

7. The adder of claim 1, wherein the one or more memories are respectively included in the one or more adding logic circuits.

8. The adder of claim 1, wherein the one or more controllers respectively control the one or more adding logic circuits or comprise an integrated controller for integrally controlling the one or more adding logic circuits.

9. The adder of claim 1, wherein the one or more controllers comprise individual controllers respectively corresponding to the one or more adding logic circuits and respectively controlling the one or more adding logic circuits, and an integrated controller for controlling the individual controllers.

10. An adding method of obtaining a maximum accumulated value of correlation values used to detect a mode in an orthogonal frequency division multiplexing (OFDM) system, the adding method comprising:
receiving input values constituting the correlation values, and accumulated values;
if one of the accumulated values is equal to or greater than a predetermined value, shifting all of the accumulated values in a direction for decreasing the accumulated values;
shifting the input values by the number of bits by which the accumulated values are shifted; and
adding the shifted accumulated values to the input values.

11. The adding method of claim 10, wherein the shifting of the accumulated values comprise:
detecting a first accumulated value in which i MSBs have a value x from among the accumulated values;
detecting a second accumulated value having the greatest size from among accumulated values other than the first accumulated value; and
shifting all of the accumulated values by a number of bits corresponding to a location N of an MSB having a logic high level from among bits of the second accumulated value.

12. The adding method of claim 11, wherein the shifting of the accumulated values comprises shifting all of the accumulated values by N−1 bits.

13. The adding method of claim 10, further comprising:
initializing a count value to zero before receiving the input values and the accumulated values; and
comparing the count value to a predetermined number of repetitions of the shifting operation after shifting the accumulated values,
wherein, if the count value is less than the predetermined number of repetitions of the shifting operation, the receiving, the shifting of the accumulated values, the shifting of the input values, and the adding are repeated.

14. The adding method of claim 13, wherein, if the count value is less than the predetermined number of repetitions of the shifting operation, the count value is increased by one, the adding is performed, and then the receiving, the shifting of the accumulated values, the shifting of the input values, and the adding are repeated.

15. The adding method of claim 13, further comprising outputting the accumulated value of the first memory as the maximum accumulated value after comparing the count value to the predetermined number of repetitions of the shifting operation,
wherein the maximum accumulated value is obtained by outputting the accumulated value of the first memory if the count value is equal to or greater than the predetermined number of repetitions of the shifting operation.

16. The adding method of claim 10, further comprising determining whether one of the accumulated values is equal to or greater than the predetermined value before shifting the accumulated values,
wherein, if one of the accumulated values is not equal to or greater than the predetermined value, the accumulated values are added to the input values without shifting the accumulated values and the input values and the receiving is performed again.
